(19) United States
(12) Patent Application Publication
(10) Pub. No.: US 2009/0052498 A1
(43) Pub. Date: Feb. 26, 2009

(54) THERMOCOUPLE

(75) Inventors: Mike Halpin, Scottsdale, AZ (US); Matt Goodman, Chandler, AZ (US)

Correspondence Address: Snell & Wilmer L.L.P. (ASM America), 400 East Van Buren Street, One Arizona Center, Phoenix, AZ, 85004-2202, US

(73) Assignee: ASM AMERICA, INC., Phoenix, AZ (US)

(21) Appl. No.: 12/193,924

(22) Filed: Aug. 19, 2008

Related U.S. Application Data
(60) Provisional application No. 60/957,998, filed on Aug. 24, 2007.

(51) Int. Cl. G01K 7/02; B05C 11/00

(52) U.S. Cl. 374/179; 118/666; 374/E07.004

(57) ABSTRACT

A thermocouple for measuring temperature at a position adjacent to a substrate being processed in a chemical vapor deposition reactor is provided. The thermocouple includes a sheath having a measuring tip. The thermocouple also includes a support tube disposed within the sheath. The thermocouple further includes first and second wires supported by the support tube. The first and second wires are formed of different metals. A junction is formed between the first and second wires, wherein the junction is located adjacent to a distal end of the support tube. A spring is disposed about a portion of the support tube. The spring is compressed to exert a spring force on the support tube to bias the junction against the measuring tip to maintain the junction in continuous contact with the measuring tip. The spring force is small enough to prevent significant deformation of the junction as well as reducing variation of spring force or junction location from one thermocouple to another.

### FIELD OF THE INVENTION

The present invention relates to a temperature sensor, and more particularly to a temperature sensor configured to enhance accuracy of temperature control in a semiconductor processing apparatus.

### BACKGROUND OF THE INVENTION

Semiconductor processing chambers are used for depositing various material layers onto a substrate surface or surfaces at low temperatures (less than 700° C.) or high temperatures (greater than 700° C.) and at atmospheric or reduced pressure within the processing chamber. One or more substrates, or workpieces, such as silicon wafers, are placed on a workpiece support within the processing chamber. Both the substrate and workpiece support are heated to a desired temperature. In a typical processing step, reactant gases are passed over the heated substrate, whereby a chemical vapor deposition (“CVD”) reaction deposits a thin layer of the reactant material onto the substrate surface(s). Through subsequent processes, these layers are made into integrated circuits, and tens to thousands or even millions of integrated devices, depending on the size of the substrate and the complexity of the circuits.

Various process parameters must be carefully controlled to ensure the high quality of the resulting deposited layers. One such critical parameter is the temperature of the substrate during each processing step. During CVD, for example, the deposition gases react at particular temperatures to deposit the thin layer on the substrate. If the temperature varies greatly across the surface of the substrate, the deposited layer could be uneven which may result in unusable areas on the surface of the finished substrate. Accordingly, it is important that the substrate temperature be stable and uniform at the desired temperature before the reactant gases are introduced into the processing chamber.

Similarly, non-uniformity or instability of temperatures across a substrate during other thermal treatments can affect the uniformity of resulting structures on the surface of the substrate. Other processes for which temperature control can be critical include, but are not limited to, oxidation, nitridation, dopant diffusion, sputter depositions, photolithography, dry etching, plasma processes, and high temperature anneals.

Methods and systems are known for measuring the temperature at various locations near and immediately adjacent to the substrate being processed. Typically, thermocouples are disposed at various locations near the substrate being processed, and these thermocouples are operatively connected to a controller to assist in providing a more uniform temperature across the entire surface of the substrate. For example, U.S. Pat. No. 6,121,061 issued to Van Bilsen teaches a plurality of temperature sensors measuring the temperature at various points surrounding the substrate, including a thermocouple placed near the leading edge of the substrate, another near the trailing edge, one at a side, and another below the center of substrate.

Often, temperature sensors, such as thermocouples, are used to measure the temperature at the center of the substrate or the temperature near the center of the substrate as a representative temperature thereof. Thermocouples typically include an elongated ceramic support member through which the leads of the thermocouple extend, and a junction between the leads is formed adjacent the end of the support member. The support member and the junction are disposed within a protective sheath, typically formed of quartz, which allows significant heat transfer through the sheath to the junction without acting as a heat sink within the processing chamber. The junction is typically in continuous contact with the inner surface of the tip of the sheath. To maintain the contact between the junction and the inner surface of the sheath, a spring is typically used to bias the support member and junction toward the tip of the sheath.

However, due to the temperatures to which the thermocouples are exposed during semiconductor processing, the contact of the junction with the inner surface of the sheath causes the junction bead to become deformed. This deformation of the bead in turn causes a drift in the subsequent temperature measurements of the thermocouple. In a deposition process that is dependent upon the consistent measurement of the relative temperature at a particular location, a drift in the temperature measurement results in changes to the overall deposition on subsequent substrates being processed. Thus, thermocouples having a drift in the temperature measurement over multiple cycles have a shorter lifetime than thermocouples little or no drift in temperature measurement over the same number of cycles. Accordingly, a thermocouple having a reduced amount of drift in temperature measurement over multiple processing cycles is needed. Additionally, a process for forming thermocouples in which the amount of drift in temperature measurement between subsequently manufactured thermocouples is minimal is needed.

### BRIEF SUMMARY OF THE INVENTION

A need exists for a thermocouple that reduces the amount of drift of the temperature measurement resulting from deformation of the junction of the wires within the measuring tip of the sheath. In one aspect of the present invention, a temperature control system for a chemical vapor reactor is provided. The control system includes at least one heating element for providing radiant heat to the reactor. The control system further includes at least one temperature sensor for providing a temperature measurement at a position adjacent to a substrate being processed within the reactor. The temperature sensor includes a vertically oriented sheath having a measuring tip, a support tube disposed within the sheath, first and second wires disposed within the support tube, and a junction formed between the first and second wires. The junction is located adjacent to a distal end of the support tube. The first and second wires are formed of different metals. A spring is disposed about a portion of the support tube. The spring exerts a spring force on the support tube to bias the junction against the measuring tip. The spring force is less than eight times a minimum amount of force necessary to overcome gravity to maintain the junction in continuous contact with the measuring tip. The temperature control system further includes a temperature controller operatively connected to the heating element(s) and the temperature sensor (s). The temperature controller is configured to receive the temperature measurement from each temperature sensor and controls power provided to the heating element(s).

In another aspect of the present invention, a thermocouple for measuring temperature at a position adjacent to a substrate being processed in a chemical vapor deposition reactor is provided. The thermocouple includes a sheath having a measuring tip. The sheath is oriented in a substantially vertical manner within the reactor. The thermocouple also includes a support tube disposed within the sheath. The thermocouple farther includes first and second wires supported by the support tube. The first and second wires are formed of different metals. A junction is formed between the first and second wires, wherein the junction is located adjacent to a distal end of the support tube. A spring is disposed about a portion of the support tube. The spring is compressed to exert a spring force to bias the junction against the measuring tip, wherein the spring force is less than eight times a minimum amount of force necessary to overcome gravity to maintain the junction in continuous contact with the measuring tip.

In yet another aspect of the present invention, a thermocouple for measuring temperature at a position adjacent to a substrate being processed in a chemical vapor deposition reactor is provided. The thermocouple includes a first wire and a second wire. The first and second wires are formed of dissimilar metals. A junction is formed by fusing a portion of the first wire with a portion of the second wire. A support tube has a first distal end and an opposing second distal end and the junction is located adjacent to the first distal end of the support tube. The thermocouple also includes a sheath configured to receive the support tube, junction, and a portion of the first and second wires therein. The sheath has a measuring tip. A spring is disposed between an outer surface of the support tube and an inner surface of the sheath. The spring has a spring force that biases the junction into contact with the measuring tip when the sheath is vertically oriented within the reactor, wherein the spring force maintains the junction in continuous contact with the measuring tip without causing significant deformation of the junction. The thermocouple further includes a plug operatively connected to the first and second wires, wherein the plug is configured to provide data from which a temperature measurement at the junction is determined.

Advantages of the present invention will become more apparent to those skilled in the art from the following description of the embodiments of the invention which have been shown and described by way of illustration. As will be realized, the invention is capable of other and different embodiments, and its details are capable of modification in various respects. Accordingly, the drawing(s) and description are to be regarded as illustrative in nature and not as restrictive.

### BRIEF DESCRIPTION OF SEVERAL VIEWS OF THE DRAWINGS

FIG. 1 is a cross-sectional view of an embodiment of a chemical vapor deposition reactor;

FIG. 2 is a cross-sectional magnified view of an embodiment of a substrate support mechanism;

FIG. 3 is a schematic of an embodiment of a temperature control system;

FIG. 4 is an embodiment of a thermocouple of the present invention;

FIG. 5 is an exploded view of a portion of the thermocouple of FIG. 4;

FIG. 6 is a sectioned cross-sectional view of the thermocouple of FIG. 4;

FIG. 7 is a magnified view of the measuring tip of the thermocouple of FIG. 4;

FIG. 8 is a magnified view of a portion of the thermocouple of FIG. 4;

FIG. 9 is an embodiment of a sheath;

FIG. 10 is an embodiment of a support tube;

FIG. 11 is an end view of the support tube of FIG. 10;

FIG. 12 is an isometric view of a junction and support tube;

FIG. 13 is a magnified view of a portion of the thermocouple of FIG. 4;

FIG. 14 is a magnified view of the assembled cap;

FIG. 15 is a cross-sectional view of an embodiment of a cap;

FIG. 16 is a cross-sectional view of a portion of the thermocouple of FIG. 4;

FIG. 17 is a cross-sectional view of a portion of the thermocouple of FIG. 4; and

FIG. 18 is a cross-sectional view of a portion of the thermocouple of FIG. 4;

FIG. 19 is a side view of an exemplary spring;

FIG. 20 is an end view of the spring of FIG. 19.

### DETAILED DESCRIPTION OF THE PREFERRED EMBODIMENT

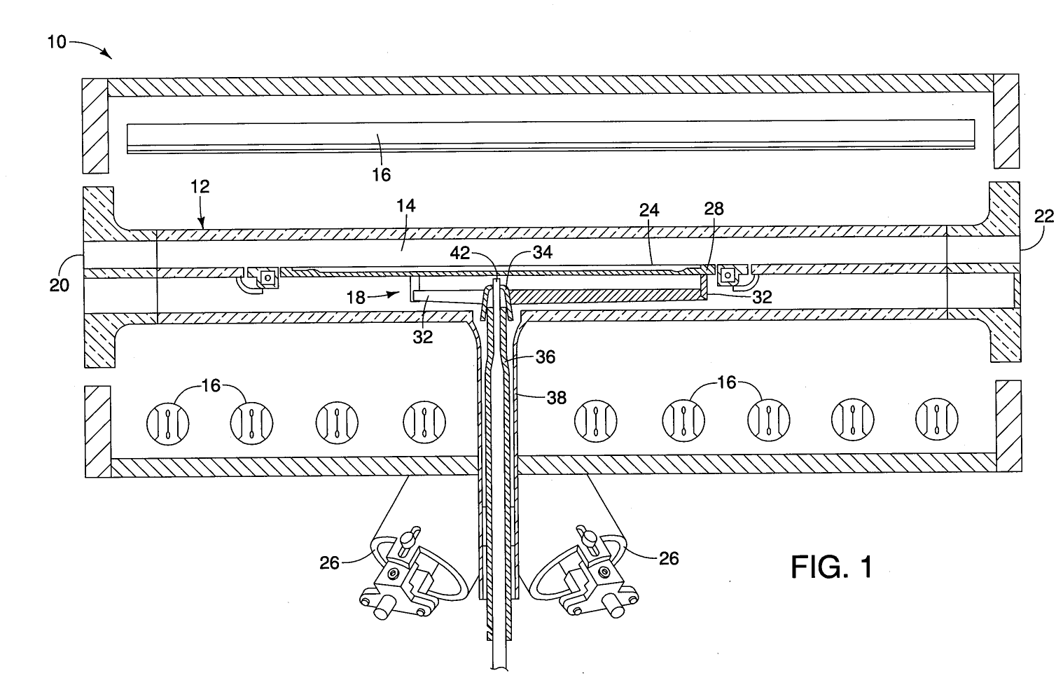

Referring to FIG. 1, an exemplary embodiment of a chemical vapor deposition (“CVD”) reactor 10 is shown. While the illustrated embodiment is a single substrate, horizontal flow, cold-wall reactor, it should be understood by one skilled in the art that the thermocouple technology described herein may be used in other types of semiconductor processing reactors as well as other applications requiring accurate temperature sensors. The reactor 10 includes a reaction chamber 12 defining a reaction space 14, heating elements 16 located on opposing sides of the reaction chamber 12, and a substrate support mechanism 18. The reaction chamber 12 is an elongated member having an inlet 20 for allowing reactant gases to flow into the reaction space 14 and an outlet 22 through which the reactant gases and process by-products exit the reaction space 14. In an embodiment, the reaction chamber 12 is formed of transparent quartz. It should be understood by one skilled in the art that the reaction chamber 12 may be formed of any other material sufficient to be substantially non-reactive relative to a deposition process therewithin.

The heating elements 16 form an upper bank and a lower bank, as shown in FIG. 1. The heating elements 16 are oriented in a spaced-apart manner relative to adjacent heating elements 16 within the same bank. In an embodiment, the heating elements 16 of the upper bank are oriented substantially perpendicular relative to the heating elements 16 of the lower bank. The heating elements 16 provide radiant energy to the reaction chamber 12 without appreciable absorption by the reaction chamber 12 walls. The heating elements 16 are configured to provide radiant heat of wavelengths absorbed by the substrate 24 being processed as well as portions of the substrate support mechanism 18. In an embodiment, a plurality of spot lamps 26 provide concentrated heat to the underside of the wafer support mechanism 18 to counteract a heat sink effect caused by cold support structures extending upwardly through the bottom wall of the reaction chamber 12.

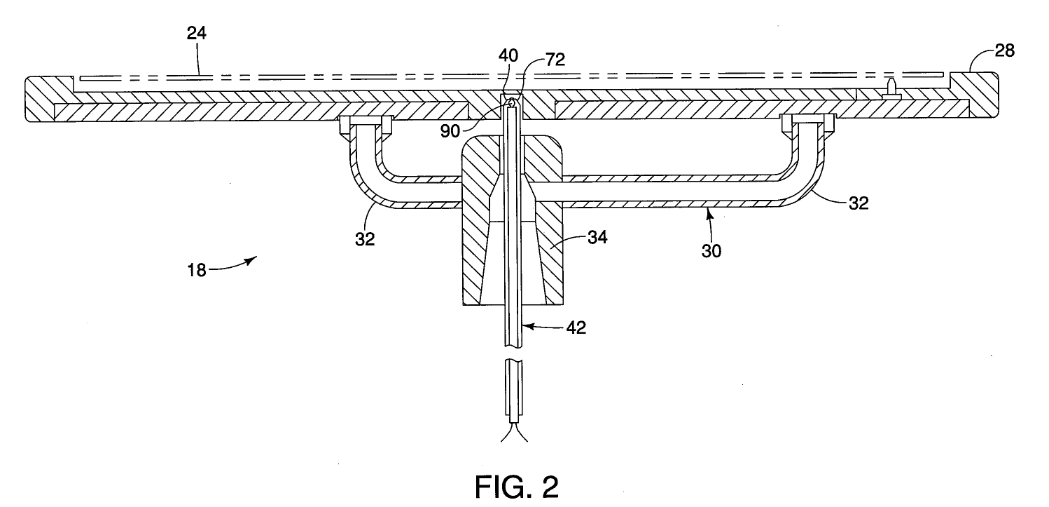

The substrate support mechanism 18 includes a substrate holder 28, upon which the substrate 24 may be disposed, and a support member 30, as shown in FIGS. 1-2. The support member 30 provides support to the substrate holder 28 through a plurality of arms 32 extending from a central body 34. The support member 30 is connected to a shaft 36 that extends downwardly through a tube 38 depending from the lower wall of the reaction chamber 12. A motor (not shown) is configured to rotate the shaft 36, thereby rotating the spider 30, substrate holder 28, and substrate 24 in a like manner during the deposition process. The substrate holder 28 includes a recessed portion 40 formed therein. The recessed portion 40 is configured to receive a temperature sensor, or thermocouple 42, for measuring the localized temperature of the substrate holder 28 immediately surrounding to the tip of the thermocouple 42.

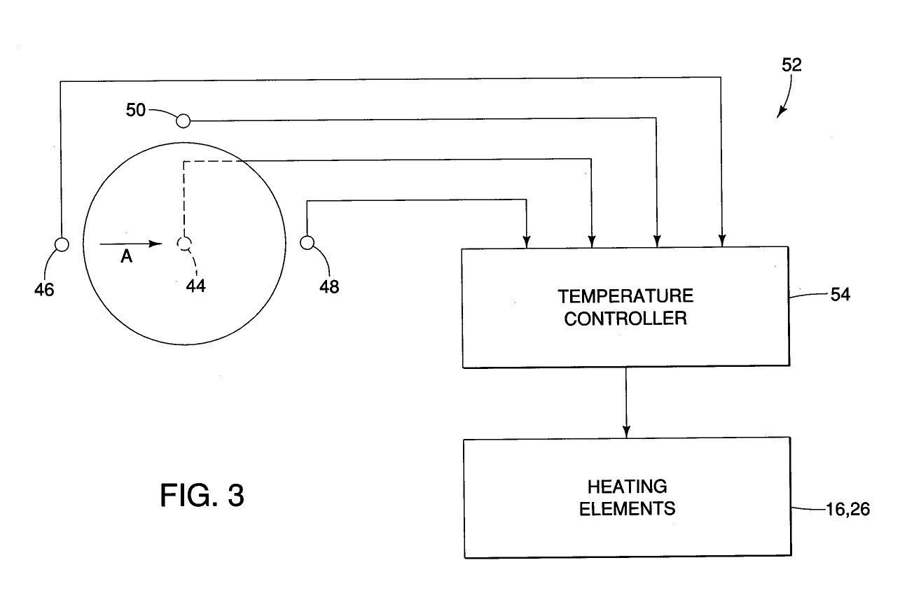

A plurality of temperature sensors are located adjacent to the substrate 24 and the substrate holder 28 for measuring temperatures at a variety of locations near the substrate 24, as shown in FIG. 3. In the illustrated embodiment, the temperature sensors include: a central temperature sensor 44 disposed within a blind hole formed in the substrate holder 28, a leading edge temperature sensor 46, a trailing edge temperature sensor 48, and at least one side edge temperature sensor 50. The leading and trailing edge temperature sensors 46, 48 are located adjacent to the front and rear edges of the substrate 24 relative to the direction of flow A of the reactant gases within the reaction space 14. The temperature sensors are configured to measure the temperature in the localized area immediately surrounding the tip of the temperature sensor.

As illustrated in FIG. 3, a temperature control system 52 for a CVD reactor 10 includes a plurality of temperature sensors 44, 46, 48, 50 located adjacent to a substrate 24 being processed. The temperature sensors 44, 46, 48, 50 are operatively connected to a temperature controller 54 for providing temperature data at the respective locations adjacent to the substrate to the temperature controller 54. The temperature controller 54 is operatively connected to the heating elements 16 (FIG. 1) and spot lamps 26 (FIG. 1) located within the CVD reactor 10. The temperature controller 54 is configured to selectively adjust the amount of energy emitted from the heating element 16 and spot lamps 26 in response to data provided by the temperature sensors 44, 46, 48, 50 to maintain a substantially uniform temperature distribution across the entire surface of the substrate 24 being processed. It should be understood by one skilled in the art that the temperature control system 52 may include any number of temperature sensors disposed at different locations for providing data to the temperature controller 54.

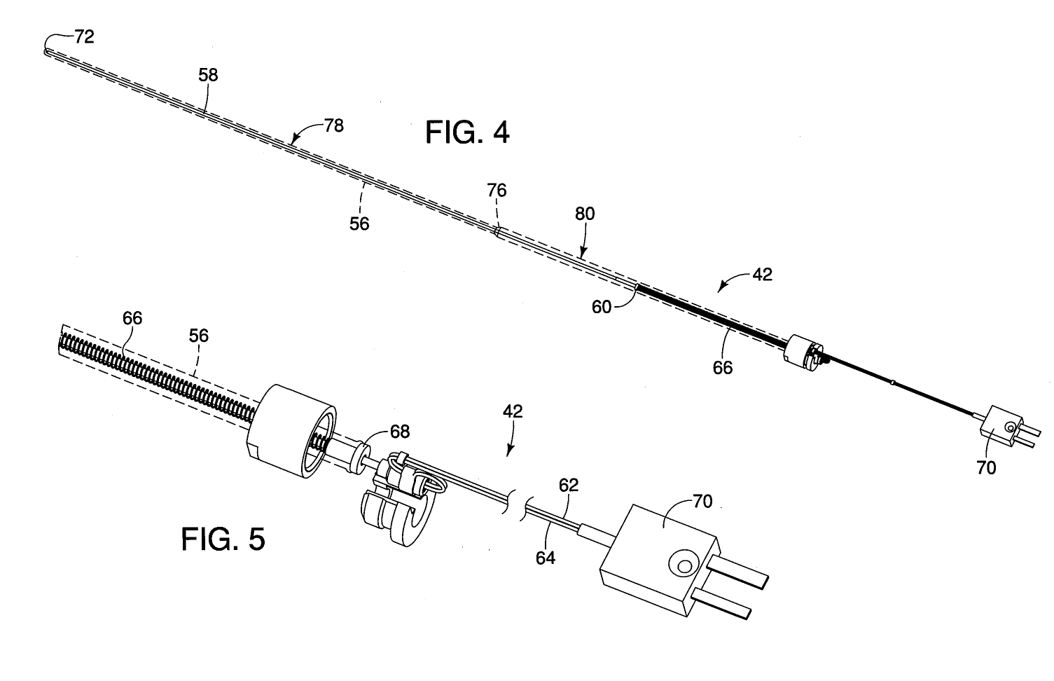

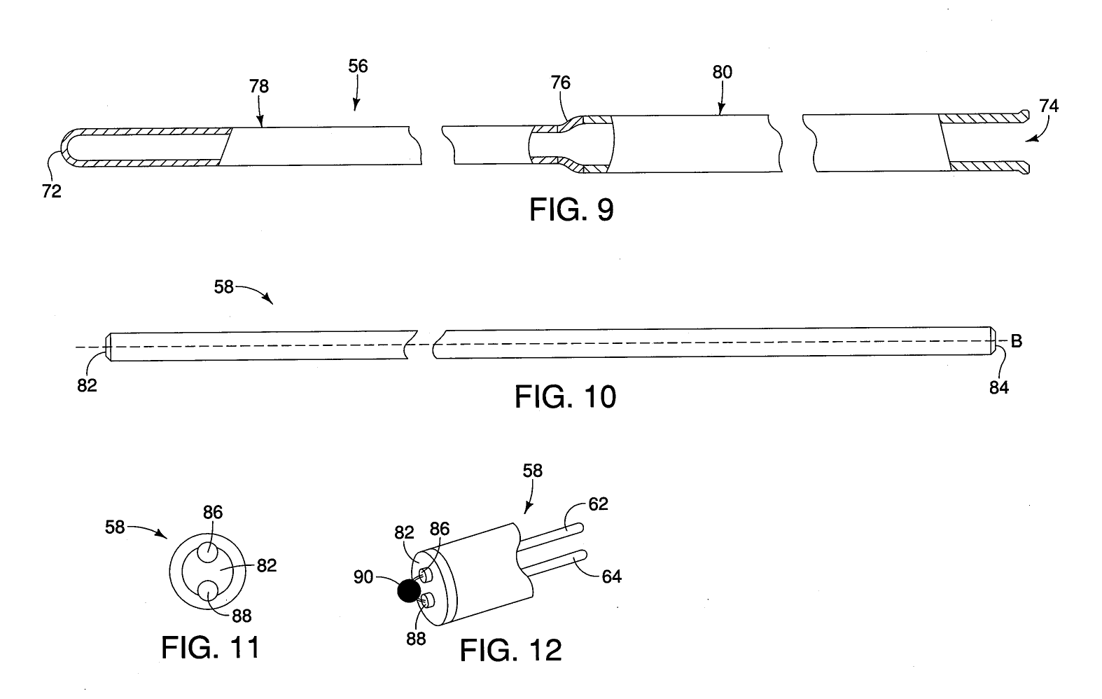

In an embodiment, the central temperature sensor 44 (FIG. 3) is a thermocouple 42, as shown in FIGS. 1-2 and 4-11. It should be understood by one skilled in the art that the other temperature sensors 46, 48, 50 may be formed as optical pyrometers, thermocouples, or any combination thereof. In an embodiment, the thermocouple 42, as shown in FIGS. 4-8, includes a sheath 56, a support tube 58, a first retainer 60, a first wire 62, a second wire 64, a spring 66, a second retainer 68, and a plug 70. The body of the thermocouple 42 in the illustrated embodiment is substantially linear. In another embodiment, the body of the thermocouple 42 is non-linear. It should be understood by one skilled in the art that the thermocouple 42 can be formed of any shape or size sufficient to ensure the measuring tip of the thermocouple is disposed at a desired location. The thermocouple 42 is configured to be disposed in a substantially vertical manner within the CVD reactor 10, wherein the measuring tip 72 of the thermocouple 42 is directed upwardly and located within the recessed portion 40 of the substrate holder 28, as shown in FIG. 1. In another embodiment, the thermocouple 42 is configured to be disposed in a substantially vertical manner within the CVD reactor 10, wherein the measuring tip 72 of the thermocouple is directed downwardly. In another embodiment, the thermocouple 42 is configured to be disposed in a substantially horizontal manner within the CVD reactor 10, wherein the measuring tip 72 is located adjacent to a side edge of a substrate being processed within the reaction chamber 12. While it should be understood by one skilled in the art that the thermocouple 42 can be used in any other orientation, the description provided herein will be directed to the thermocouple being oriented in a substantially vertical manner in which the measuring tip 72 is directed upwardly.

In an embodiment, the sheath 56 is a generally elongated, substantially linear member, as shown in FIGS. 1-2 and 9. The sheath 56 is substantially hollow and has a generally circular cross-section, but it should be understood by one skilled in the art that the cross-section of the sheath 56 may correspond to the cross-section of the support tube 58 disposed therein. The measuring tip 72 forms the first distal end of the sheath 56, and an opening 74 is formed at the opposing distal end of the sheath 56. In an embodiment, the diameter of the sheath 56 adjacent to the opening 74 is greater than the diameter of the sheath 56 adjacent to the measuring tip 72. The sheath 56 has a transition portion 76 located between the measuring tip 72 and the opening 74 at which the diameter of the sheath 56 changes. The transition portion 76 provides two distinct portions of the sheath 56, each portion having a different diameter. The first portion 78 of the sheath 56 that extends between the transition portion 76 and the measuring tip 72 has a diameter that is smaller than the diameter of the second portion 80 of the sheath 56 that extends between the transition portion 76 and the opening 74. The second portion 80 surrounds the support tube 58, yet provides an additional gap between the outer surface of the support tube 58 and the inner surface of the sheath 56 to allow the spring 66 to be disposed about the outer surface of the support tube 58 within the second portion 80 of the sheath 56. Because the spring 66 is disposed only within the second portion 80 of the sheath 56, the first portion 78 of the sheath 56 has a smaller diameter to prevent significant lateral, or radial movement of the support tube 58 within the first portion 78 of the sheath 56. In an alternative embodiment, the diameter of the sheath 56 is substantially the same along the entire length of the sheath 56 between the opening 74 and the measuring tip 72.

In an embodiment, the sheath 56 is formed of quartz. In another embodiment, the sheath 56 is formed of silicon carbide. It should be understood by one skilled in the art that the sheath 56 should be formed of any material able to withstand the range of temperatures as well as cyclical temperature and pressure changes experienced by the thermocouple 42. In an embodiment, a sheath 56 is formed of quartz and the measuring tip 72 is coated with silicon nitride (SiN) or any other surface treatment applied thereto to extend the life of the sheath 56. In yet another embodiment, a cap (not shown), such as a silicon-carbide (SiC) cap, is applied at the measuring tip 72 of the sheath to provide better heat transfer between the ambient environment and the wires 62, 64 located within the support tube 58 disposed within the sheath 56.

In an embodiment, the support tube 58 of the thermocouple 42 is a generally elongated, cylindrical member having a longitudinal axis B, as illustrated in FIG. 10. In another embodiment in which the thermocouple 42 is non-linear, the support tube 58 is generally formed as the same shape as the sheath 56 in which the support tube 58 is disposed. The support tube 58 includes a first distal end 82 and an opposing second distal end 84. When assembled, the first distal end 82 of the support tube 58 is adjacent to the measuring tip 72 of the sheath 56, and the second distal end 84 of the support tube 58 is adjacent to the opening 74 of the sheath 56. In an embodiment, the support tube 58 has a generally circular cross-section extending along the entire length of the support tube 58 between the first and second distal ends 82, 84. It should be understood by one skilled in the art that the cross-sectional shape of the support tube 58 may be formed as any shape. In an embodiment, the support tube 58 is formed of ceramic. It should be understood by one skilled in the art that the support tube 58 may be formed of any material sufficient to withstand the cyclic temperature variations as well as the range of temperatures and pressures to which the thermocouple 42 is exposed.

In an embodiment, the support tube 58 includes a first bore 86 and a second bore 88, as shown in FIGS. 7 and 11-12. The first and second bores 86, 88 are formed through the support tube 58 and extend the entire length thereof between the first distal end 82 and the second distal end 84 in a substantially parallel manner relative to the longitudinal axis B of the support tube 58. The first bore 86 is configured to receive the first wire 62, and the second bore 88 is configured to receive the second wire 64. It should be understood by one skilled in the art that additional bores may be formed along the entire length of the support tube 58 for receiving additional wires, allow additional air circulation through the thermocouple 42, or any combination thereof.

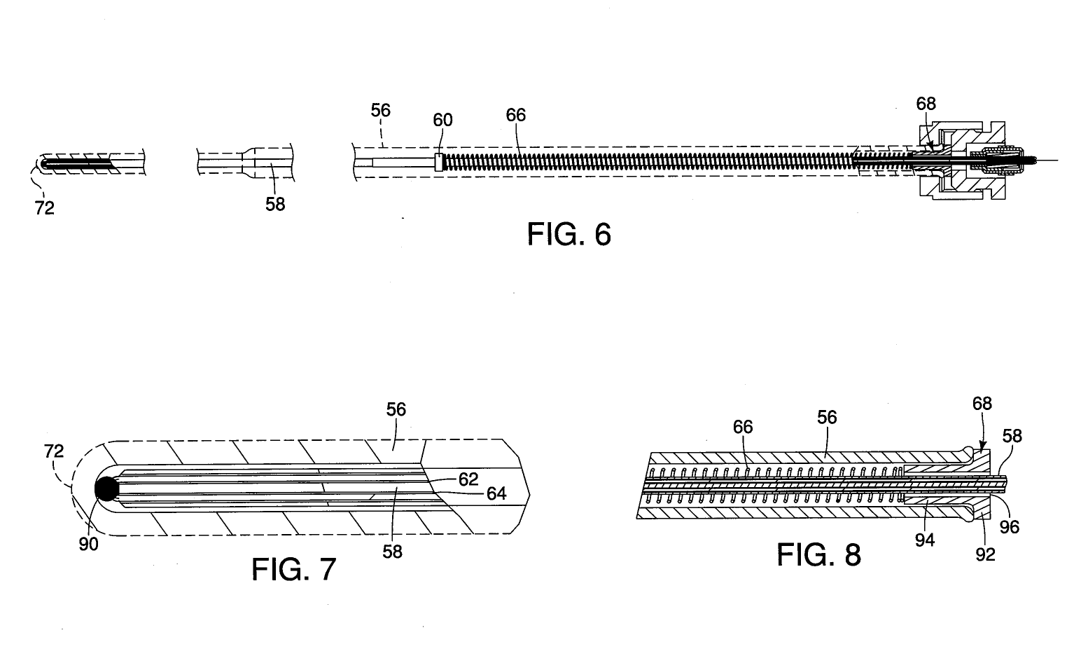

The first and second wires 62, 64 are disposed within the first and second bores 86, 88 and extend the entire length of the support tube 58, and the first and second wires 62, 64 also extend beyond both the first and second distal ends 82, 84 of the support tube 58, as shown in FIGS. 6 and 12. In an embodiment, the portion of the first and second wires 62, 64 extending beyond the first distal end 82 of the support tube 58 are operatively connected, or fused together, adjacent to the first distal end 82 of the support tube 58 to form a junction 90, as shown in FIGS. 7 and 12. The ends of the first and second wires 62, 64 are operatively fused to each other by melting the ends together to form a bead. It should be understood by one skilled in the art that the ends of the first and second wires 62, 64 extending beyond the first distal end 82 of the support tube 58 can be fused together, or connected, in any other manner that allows the first and second wires 62, 64 to form an electrical connection therebetween. The free ends of the first and second wires 62, 64 opposite the junction 90, which extend from the bores 86, 88 at the second distal end 84 of the support tube 58, are operatively connected to the plug 70 (FIG. 4). The first and second wires 62, 64 are formed of dissimilar metals to form an electrical connection therebetween. In an embodiment, the first wire 62 is formed of Platinum, and the second wire 64 is formed of a Platinum alloy having 13% Rhodium. It should be understood by one skilled in the art that the first and second wires 62, 64 can be formed of any dissimilar metals sufficient to form a thermocouple therebetween. When the thermocouple 42 is assembled, as illustrated in FIG. 7, the junction 90 of the first and second wires 62, 64 is located immediately adjacent to the measuring tip 72 of the sheath 56. In the preferred embodiment, the junction 90 is in contact with the inner surface of the sheath 56 at the measuring tip 72. In another embodiment, the junction 90 is spaced-apart from the inner surface of the sheath at the measuring tip 72.

In an embodiment, the diameter of each of the first and second wires 62, 64 is about 0.010 inches. In another embodiment, the diameter of each of the first and second wires 62, 64 is about 0.014 inches. It should be understood by one skilled in the art that the first and second wires 62, 64 can be formed of any diameter. It should also be understood by one skilled in the art that the diameter of the first and second wires 62, 64 may be different. The first and second bores 86, 88 are sized and shaped to receive the first and second wires 62, 64, respectively. The first and second bores 86, 88 are sized to allow the first and second wires 62, 64 to freely thermally expand radially and axially therewithin. Accordingly, first and second bores 86, 88 have a cross-sectional area that is slightly larger than the cross-sectional area of the corresponding wires 62, 64.

As shown in FIGS. 4 and 6, a first retainer 60 is operatively connected to the outer surface of the support tube 58 at a spaced-apart distance from the second distal end 84 of the support tube 58. In an embodiment, the first retainer 60 is formed separately from the support tube 58 and later fixedly attached to the support tube 58. In an embodiment, the first retainer 60 is formed of Rulon® and is shrink-fitted to the outer surface of the support tube 58, thereby fixedly attaching the first retainer 60 to the support tube 58. It should be understood by one skilled in the art that the first retainer 60 can be formed of any material sufficient to withstand the range of temperatures as well as the cyclical temperature and pressure changes experienced by the thermocouple 42. In another embodiment, the support tube 58 and the first retainer 60 are formed as a single member. In an embodiment, the first retainer 60 contacts the inner surface of the sheath 56 to ensure that the support tube 58 is secured within the sheath 56, thereby preventing substantial lateral, or radial, movement of the support tube 58 within the sheath 56. In another embodiment, the first retainer 60 is spaced-apart from the inner surface of the sheath 56.

In an embodiment, the second retainer 68, as shown in FIGS. 5 and 8, is disposed within the opening 74 of the sheath 56. The second retainer 68 includes a ring 92, a body 94, and an aperture 96 extending longitudinally through the ring 92 and body 94. The second retainer 68 is disposed adjacent to the end of the sheath 56 and is configured to receive the support tube 58 within the aperture 96. In an embodiment, the second retainer 68 is secured within the opening 74 of the sheath 56 by an interference fit, or friction fit, wherein the body 94 extends into the sheath 56 while the ring 92 is in mating contact with the surface of the sheath 56 immediately surrounding the opening 74 thereto. It should be understood by one skilled in the art that the second retainer 68 may be secured to the sheath 56 by friction fit or any other means sufficient to maintain the second retainer 68 in a removable, yet substantially fixed, relationship with the sheath 56. The diameter of the aperture 96 through the second retainer 68 is large enough to receive the support tube 58, yet prevent significant lateral or radial movement of the support tube 58 relative to the sheath 56 while allowing the support tube 58 to thermally expand freely in the radial and longitudinal manners within the aperture 78 relative to the sheath 56.

Referring to FIGS. 6 and 8, a spring 66 is located about the outer surface of the support tube 58, extending between the first retainer 60 and the second retainer 68. One end of the spring 66 contacts the second retainer 68, and the other end of the spring 66 contacts the first retainer 60. Because the second retainer 68 remains in a substantially fixed position and the first retainer 60 is moveable relative to the second retainer 68, the spring 66 biases the first retainer 60, support tube 58, and the junction 90 toward the measuring tip 72 of the sheath 56. The spring 66 is configured to maintain the junction 90 in contact with, or immediately adjacent to, the measuring tip 72 of the sheath 56. The greater the distance that the junction 90 is located away from contacting the measuring tip 72, the less accurate the temperature measurement becomes. The biasing force applied by the spring 66 should be just large enough to maintain continuous contact between the junction 90 and the inner surface of the sheath 56 at the measuring tip 72.

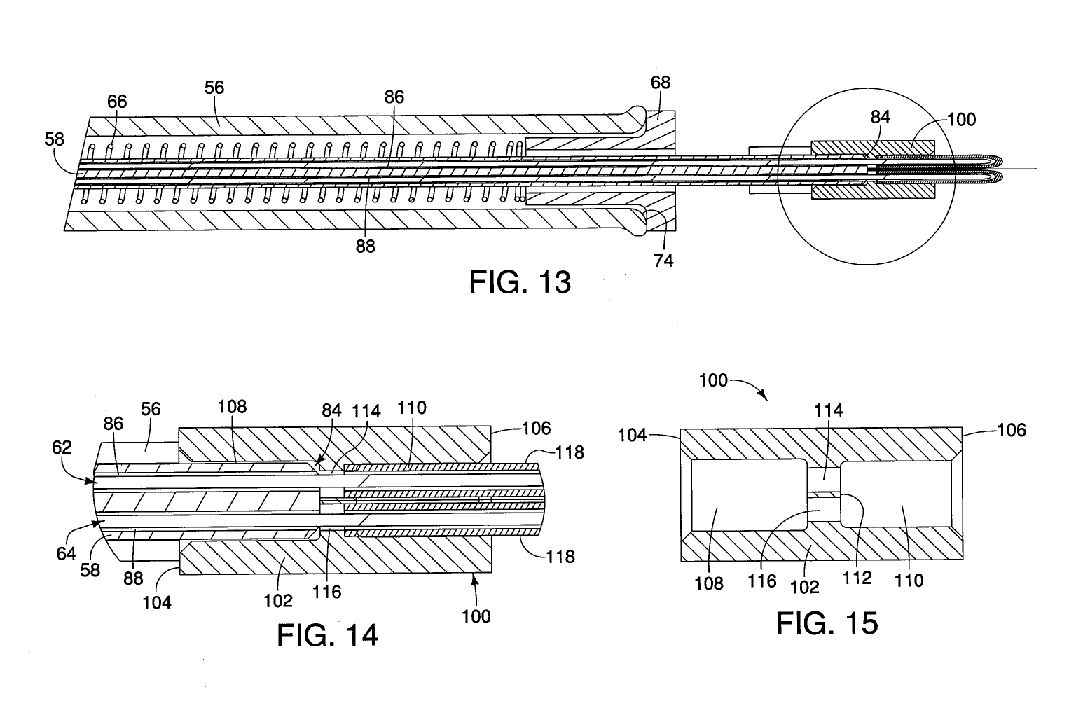

As shown in FIGS. 13-14, the second distal end 84 of the support tube 58 extends beyond the opening 74 of the sheath 56 through the second retainer 68. A cap 100 is operatively attached to the second distal end 84 of the support tube 58 in a substantially fixed manner such that the cap 100 is prevented from rotating relative to the support tube 58. In an embodiment, the cap 100 is formed of Delrint plastic. In another embodiment, the cap 100 is formed of polyetheretherkeytones (PEEK). In yet another embodiment, the cap 100 is formed of polyetherimide (PEI). For high-temperature applications, PEEK and PEI provide greater durability. It should be understood by one skilled in the art that the cap 100 may be formed of any material sufficient to withstand large temperature ranges as well as resist torsional movement. In an embodiment, as illustrated in FIG. 15, the cap 100 is an elongated, one-piece cylindrical member having a body 102, a first end 104, and a second end 106. In another embodiment, the body 102 of the cap 100 has a square cross-sectional shape. It should be understood by one skilled in the art that the body 102 of the cap 100 may have any cross-sectional shape. At the first end 104, a first bore 108 is formed into the body 102. The first bore 108 extends from the first end 104 through at least a portion of the longitudinal length of the body 102. In an embodiment, the first bore 108 is circular. The first bore 108 is configured to receive the second distal end 84 of the support tube 58. Accordingly, the first bore 108 is substantially the same size and shape as the outer surface of the support tube 58 received therein. A second bore 110 is formed into the second end 106 of the body 102. In an embodiment, the second bore 110 extends from the second end 106 through at least a portion of the longitudinal length of the cap 100. The cross-sectional shape of the second bore 110 may be round, oval, square, or any other shape sufficient to envelop the first and second wires 62, 64. In an embodiment, the cross-sectional shape of the second bore 110 is the same as the first bore 108. In another embodiment, the cross-sectional shape of the second bore 110 is different than the first bore 108.

In an embodiment, the first and second bores 110 extend from the first and second ends 104, 106 of the cap 100, respectively, substantially the same distance, as shown in FIG. 15. It should be understood by one skilled in the art that the depth of the first and second bores 108, 110 may be the same, the first bore 108 may be longer than the second bore 110, or the second bore 110 may be longer than the first bore 108. In an embodiment, the size and shape of the first and second bores 108, 110 are substantially the same such that both bores may receive the second distal end 84 of the support tube 58, thereby ensuring that the second distal end 84 is correctly received into either bore 108, 110. In another embodiment, the size and shape of the first and second bores 106, 108 are different such that the first bore 108 is the only bore capable of receiving the second distal end 84 of the support tube 58.

As shown in FIG. 15, the first and second bores 108, 110 are separated by a web 112. The web 112 forms the base of both bores 108, 110 in the cap 100. The surface of the web 112 at the base of the first bore 108 is substantially the same shape as the end surface of the second distal end 84 of the support tube 58 such that the second distal end 84 is disposed in an abutting relationship with the corresponding surface of the web 112. A first aperture 114 and a second aperture 116 are formed through the web 112. The first aperture 114 is configured to receive the first wire 62 that extends from the second distal end 84 of the support tube 58, and the second aperture 116 is configured to receive the second wire 64 that likewise extends from the second distal end 84 of the support tube 58. The diameter of the first and second apertures 114, 116 are slightly larger than the diameter of the corresponding wire 62, 64 received therein to allow the wires 62, 64 to slide or translate through the first and second apertures 114, 116 when the wires 62, 64 are subject to thermal expansion or contraction. In an embodiment, the diameter of the first and second apertures 114, 116 is about 0.010 inches. In another embodiment, the diameter of the first and second apertures 114, 116 is about 0.014 inches. In an embodiment, the diameter of the first aperture 114 is substantially the same as the diameter of the second aperture 116. In another embodiment, the diameter of the first aperture 114 is different than the diameter of the second aperture 116.

During assembly, the first and second apertures 114, 116 are aligned with the bores 86, 88 of the support tube 58 such that the first and second wires 62, 64 extend from the second distal end 84 of the support tube 58 and through the web 112 of the cap 100 in a substantially linear manner, as shown in FIG. 14. By aligning the apertures 114, 116 in the web 112 with the bores 86, 88 of the support tube 58, any potential shearing stress resulting from a mis-aligned cap 100 relative to the support tube 58 can be greatly reduced or eliminated. Additionally, a properly aligned cap 100 also ensures that the wires 62, 64 remain spaced apart, thereby avoiding a potential short circuit of the wires 62, 64. As the wires 62, 64 extend through the bores 86, 88 of the support tube 58 and through the apertures 114, 116 in the web 112 of the cap 100, the wires remain separated and exposed, without a protective covering. The spaced-apart bores and apertures safely maintain the wires 62, 64 in a spaced-apart, separated relationship.

The first and second wires 62, 64 extending through the apertures 114, 116 in the cap 100 are covered with a Teflon® tube 118 to further prevent the wires from contacting each other, as shown in FIG. 14. Each of the wires 62, 64 is inserted into a tube 118 such that the end of the tube is located within the second bore 110 of the cap 100. In an embodiment, the end of both tubes 118 covering the wires 62, 64 are in an abutting relationship with the web 112 prior to the thermocouple 42 being installed into a tool. The tubes 118 cover each of the wires 62, 64 between the cap 100 and the plug 70, to which the first and second wires 62, 64 are attached.

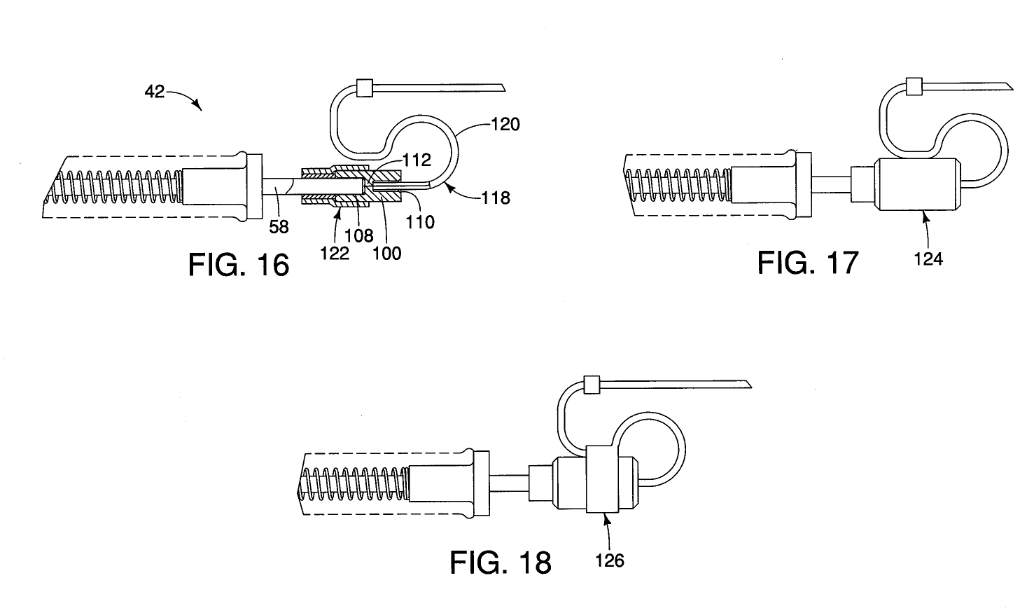

FIGS. 16-18 illustrate an exemplary assembly process for assembling the thermocouple 42. FIG. 16 show the support tube 58 inserted into the first bore 108 of the cap 100 in which the first and second apertures 114, 116 through the web 112 of the cap 100 are aligned with the bores 86, 88 of the support tube 58 such that the first and second wires 62, 64 remain substantially linearly aligned and in a spaced-apart relationship. The first and second wires 62, 64 extending from the first and second apertures 114, 116 in the cap 100 are covered by the Teflon® tubes 118. The first and second wires 62, 64 are adapted to form a loop 120 extending from the second bore 110 of the cap 100. In an embodiment, the radius of curvature of the loop 120 is between about 1 mm and 12 mm. In another embodiment, the radius of curvature of the loop 120 is between about 3 mm and 7 mm. In a further embodiment, the radius of curvature of the loop 120 is about 5 mm.

FIG. 16 further illustrates an embodiment in which a shrink sleeve 122 is disposed about the first end 104 of the cap 100 and the portion of the support tube 58 adjacent to the first distal end 104 of the cap 100. The shrink sleeve 122 is adapted to maintain the alignment between the first and second bores 86, 88 in the support tube 58 with the first and second apertures 114, 116 in the web 112 of the cap 100. The shrink sleeve 122 is also configured to prevent rotation of the cap 100 relative to the support tube 58. In another embodiment, the cap 100 includes an indexing detent (not shown) and the support tube 58 includes an indexing protrusion (not shown) adapted to be received in the indexing detent to positively locate the cap 100 relative to the support tube 58 and to prevent rotation of the cap 100 relative to the support tube 58. After the shrink sleeve 122 is connected, a protective sleeve 124 is disposed about the cap 100 and the support tube 58, as shown in FIG. 17. FIG. 18 illustrates a band 126 is operatively connected about the protective sleeve 124 to secure a portion of the loop 120 to the protective sleeve 124. The band 126 secures a portion of the loop 120 to maintain a predetermined radius of curvature of the loop 120. The assembled thermocouple 42 is then incorporated into a machine or tool requiring a temperature sensor.

When the thermocouple 42 is installed into the CVD reactor 10 in a vertical manner in which the measuring tip 72 is directed upwardly, as shown in FIG. 2, the measuring tip 72 is disposed within the recessed portion 40 of the substrate holder 28. It should be understood that the thermocouple 42 may also be horizontally aligned or aligned at any other orientation. The distance between the measuring tip 72 and the surface of the recessed portion 40 nearest to the substrate 24 is a critical distance with respect to the accuracy and consistency of the temperature measurement of the thermocouple 42. It follows that the distance between the junction 90 of the thermocouple 42 and the inner surface of the sheath 56 at the measuring tip 72 is likewise critical. Accordingly, it is preferred that the junction 90 remain in constant contact with the inner surface of the sheath 56 at the measuring tip 72. The biasing or spring force of the spring 66 acts on the first retainer 60 to bias the support tube 58 and the junction 90 toward the measuring tip 72. When the thermocouple 42 is installed in a substantially vertical manner such that the measuring tip 72 is directed upwardly, gravity tends to cause the support tube 58 and junction 90 to separate from the measuring tip 72. Accordingly, the spring force of the spring 66 must be sufficient to overcome the gravitational forces to ensure continuous contact between the junction 90 and the measuring tip 72 when the thermocouple 42 is vertically oriented as illustrated in FIG. 2.

Over the lifetime of a thermocouple 42, the thermocouple 42 is subjected to a range of temperatures between room temperature upon installation and about 1200° C. or higher during a CVD or other semiconductor manufacturing process within a reaction chamber 12. Additionally, the thermocouple 42 is typically subject to cyclical temperature changes for a multitude of processing cycles. The repetitive cycling of temperatures within the CVD reactor 10 may lead to the degradation, or drift, in the accuracy of the temperature measurement of the thermocouple 42, thereby leading to a failure of the thermocouple 42. In prior art thermocouples in which a spring biases the junction of the wires toward a measuring tip, the spring force was multiple times greater than the minimum force required to maintain the junction in continuous contact with the measuring tip of the sheath. As a result of repeated high-temperature cyclical cycles, the junction deforms to fit the contour of the inner surface of the sheath at the measuring tip. When a thermocouple 42 is installed in a CVD reactor 10, the temperature control system 52 is calibrated using the newly-installed thermocouple 42, and the calibration is based at least in part upon the newly-installed thermocouple 42. As the junction deforms and conforms to the contour of the measuring tip, more heat is conducted to the junction and through the wires. The increased contact between the junction and the sheath increases the temperature measured by the thermocouple, resulting in the temperature control system to decrease the power to the heating elements which lowers the temperature within the reaction space. The change in the measured temperature resulting from more heat being conducted to the junction due to the deformation of the junction causes a change in the overall CVD processing conditions as the system was calibrated based upon the un-deformed junction of the thermocouple. Such changes in processing conditions also results in a change in the deposition rate onto the substrate.

The thermocouple 42 of the present invention, an exemplary embodiment of which is illustrated in FIGS. 4-18, provides improvements over the prior art, including, but not limited to, an increase in the cycles to failure and a decrease in the amount of deformation of the junction 90 at the measuring tip 72, thereby reducing the amount of drift of the measured temperature. The spring 66 extending between the first and second retainers 60, 68 provides a minimum amount of spring force on the first retainer 60 of the thermocouple 42 to bias the junction 90 toward the measuring tip 72 to provide continuous contact between the junction 90 and the inner surface of the sheath 56 at the measuring tip 72. The spring force applied to the first retainer 60, which is transferred to the support tube 58, is minimized to reduce the amount of stress and strain on the junction 90 as the junction contacts the inner surface of the sheath 56 at the measuring tip 72. The spring force of the spring 66 is a function of the spring rate, spring length, and the distance that the spring is compressed. In an embodiment, the length of the uncompressed spring 66 is between about one-half and nine inches (0.5-9 in.). In another embodiment, the length of the uncompressed spring 66 is between about one and five inches (1-5 in.). In another embodiment, the length of the uncompressed spring 66 is between about three and a half and four and a half inches (3.5-4.5 in). However, it should be understood by one skilled in the art that the uncompressed spring can have any length sufficient to provide the minimum amount of spring force necessary to maintain continuous contact between the junction 90 and the measuring tip 72 of the sheath 56. It should also be understood by one skilled in the art that the repeatability of the length of the spring 66 used in manufacturing each successive thermocouple 42 provides a more repeatable spring force when the spring 66 is compressed a predetermined distance, particularly when the spring constant of the spring 66 remains substantially the same for each spring 66.

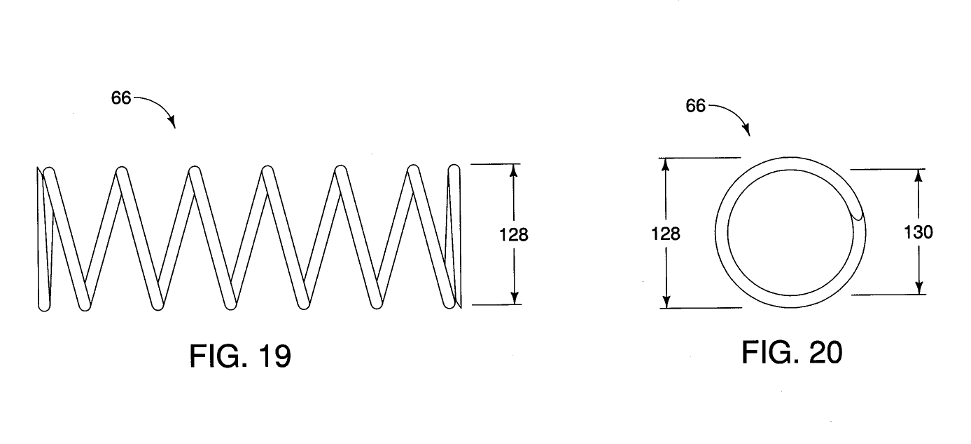

In an embodiment, the spring 66 is a helical spring having an outer diameter 128, as shown in FIGS. 19-20, of about 0.125 inches, an inner diameter 130 of about 0.105 inches, and a spring rate of about 0.08 pounds per inch (lb/in). The inner diameter 130 of the spring 66 is sized large enough to fit about the outer surface of the support tube 58, and the outer diameter 128 of the spring 66 is sized small enough to fit within the second portion 80 of the sheath 56. It should be understood by one skilled in the art that the inner and outer diameters 126, 124 of the spring 66 should be sized to allow the spring 66 to be located between the outer surface of the support tube 58 and the inner surface of the sheath 56 when the thermocouple 42 is assembled. In another embodiment, the spring rate of the spring 66 is between about 0.01 and 6 pounds per inch (lb/in). In an embodiment, the spring 66 is formed of stainless steel. In another embodiment, the spring 66 is formed of a plastic material. In further embodiments, the spring 66 is formed of brass, titanium, chrome vanadium, beryllium copper, phosphor bronze, or any other metal sufficient to withstand the cyclical temperatures to which the thermocouple 42 is exposed without a significant decrease in the compression rate of the spring 66.

In an embodiment of the thermocouple 42 that is vertically aligned such that the measuring tip 72 is directed upwardly, the weight of the members of the thermocouple that are supported by the spring 66 is between about 5.62 grams and about 5.57 grams. In an embodiment, the spring 66 has a spring rate of about 44.624 grams per inch (g/in), or about 0.08 pounds per inch (lb/in). Taking into consideration the allowable tolerances of the thermocouple components, the force needed to maintain the junction in continuous contact with the measuring tip is about 3.45 grams. With a 100% safety margin, the spring force required is about 18.14 grams. With a spring 66 having a spring rate of 0.08 lb/in, the first and second retainers 60, 68 are spaced apart a distance to compress the spring by 0.5 inches. The spring 66 having a spring rate and distance of compression sufficient to provide the minimum amount of force necessary to maintain the junction 90 in continuous contact with the measuring tip 72 minimizes the amount of deformation of the junction 90, thereby reducing the amount of drift in the measured temperature relative to a spring having a substantially greater spring force. It should be understood by one skilled in the art that the weights, distances, and spring forces provided above are exemplary only. It should also be understood by one skilled in the art that the spring rate and corresponding compression distance differs between different spring configurations, but the assembled thermocouple should include a spring having a spring rate and compression distance that provides a minimum amount of spring force necessary to maintain the junction in continuous contact with the inner surface of the sheath at the measuring tip to reduce the amount of measured temperature drift relative.

In an embodiment of a vertically aligned thermocouple 42 in which the measuring tip 72 is directed upwardly, the spring 66 provides a spring force on the first retainer 60 that is less than five (5) times the minimum amount of spring force necessary to overcome the gravitational forces acting on the vertically-oriented thermocouple 42 components to maintain the junction in continuous contact with the measuring tip. In another embodiment, the spring 66 provides a spring force on the first retainer 60 between about 1-5 times the minimum amount of spring force necessary to overcome the gravitational forces acting on the vertically-oriented thermocouple 42 components to maintain the junction in continuous contact with the measuring tip. In yet another embodiment, the spring 66 provides a spring force on the first retainer 60 about twice the minimum amount of spring force necessary to maintain the junction in continuous contact with the measuring tip. In an embodiment, the spring 66 exerts a spring force on the first retainer 60 of between about ten grams (10 g) and about three hundred grams (300 g). In another embodiment, the spring 66 exerts a spring force to the support tube 58 of between about twenty grams (20 g) and about one hundred grams (100 g). In a further embodiment, the spring 66 exerts a spring force to the support tube 58 of between about eighteen grams (18 g) and about twenty grams (20 g). However, it should be understood by one skilled in the art that the spring force necessary to maintain continuous contact between the junction and the measuring tip of the sheath will vary, depending upon the relative weights of the components upon which the spring force is to be applied when the thermocouple is vertically aligned to ensure continuous contact between the junction 90 and the measuring tip 72.

In an embodiment of a vertically aligned thermocouple 42 in which the measuring tip 72 is directed downwardly, the spring 66 provides a biasing force to oppose the gravitational effects on the thermocouple components that would otherwise force the junction 90 into contact with the measuring tip 72 of the sheath 56. Although contact between the junction 90 and the measuring tip 72 is desired, the weight of the thermocouple components such as the support tube 58 may provide a force onto the junction 90 that would cause the junction 90 to deform after repeated cycles within the reaction chamber 12. The spring 66 is operatively connected to the first retainer 60 to provide a resistive force, thereby biasing the junction 90 away from the measuring tip. The spring force applied by the spring 66 on the first retainer 60 is enough to counter the gravitational forces applied on the junction while ensuring continuous contact between the junction 90 and the measuring tip 72 of the sheath 56 such that the junction 90 does not become deformed.

In an embodiment of a horizontally aligned thermocouple 42, the spring 66 provides a spring force applied to the first retainer 60 to bias the junction 90 into continuous contact with the measuring tip 72 of the sheath 56. While the spring 66 in the horizontally-aligned thermocouple 42 does not need to provide a biasing force to overcome or counter gravitational effects, the spring 66 is configured to provide a minimum spring force to bias the junction 90 to ensure continuous contact with the sheath 56 without causing the junction 90 to deform.

Because significant deformation of the junction 90 being biased into contact with the measuring tip 72 due to excessive biasing force causes a drift in the temperature measurement of the thermocouple 42 over multiple processing cycles of the CVD reactor, the spring force of the spring 66 should be minimized to reduce the amount of deformation of the junction 90, thereby reducing the overall drift of the temperature measurement of the thermocouple 42. Significant deformation of the junction 90 results when a drift in the temperature measured is more than one degree Celsius (>1° C.) relative to the baseline that was established when the thermocouple 42 was first installed and calibrated. Accordingly, the spring force applied by the spring to bias the junction 90 into continuous contact with the measuring tip 72 should not cause significant deformation of the junction 90. In an embodiment, the spring force applied by the spring 66 results in a drift in the temperature measured by the thermocouple 42 of less than one degree Celsius (<1° C.). In another embodiment, the spring force applied by the spring 66 results in a drift in the temperature measured by the thermocouple 42 of less than one-half degree Celsius (<0.5° C.). In a further embodiment, the spring force applied by the spring 66 produces a drift in the temperature measured by the thermocouple 42 between about zero degrees Celsius (0° C.) and one-half degree Celsius (0.5° C.). It should be understood by one skilled in the art that the deformation of the junction 90 can result from the amount of spring force applied to maintain the junction 90 in contact with the measuring tip 72, the thermocouple being subjected to any number of processing cycles of the reactor 10, or a combination thereof.

While preferred embodiments of the present invention have been described, it should be understood that the present invention is not so limited and modifications may be made without departing from the present invention. The scope of the present invention is defined by the appended claims, and all devices, process, and methods that come within the meaning of the claims, either literally or by equivalence, are intended to be embraced therein.

What is claimed is:

1. A temperature control system for controlling a temperature within a chemical vapor deposition reactor comprising:
at least one heating element;
at least one temperature sensor for providing a temperature measurement within said reactor, said temperature sensor comprising:
a sheath having a measuring tip;
a support tube at least partially disposed within said sheath;
a first wire and a second wire disposed within said support tube, said first and second wires formed of different metals;
a junction formed between an end of both of said first and second wires, said junction being located adjacent to a distal end of said support tube; and
a spring disposed about a portion of said support tube, said spring exerting a minimum spring force on said support tube to bias said junction into contact with said measuring tip to provide continuous contact between said junction and said measuring tip without causing deformation of said junction; and
a temperature controller operatively connected to said at least one heating element and said at least one temperature sensor to control said temperature within said reactor.

2. The temperature control system of claim 1, wherein said spring force is between one and five times the minimum amount of force necessary to maintain said junction in continuous contact with said measuring tip.

3. The temperature control system of claim 1, wherein said spring force is between one and two times the minimum amount of force necessary to maintain said junction in continuous contact with said measuring tip.

4. The temperature control system of claim 1, wherein said spring force is a resistive force that biases said junction away from said measuring tip while providing continuous contact between said junction and said measuring tip.

5. The temperature control system of claim 1, wherein said at least one temperature sensor is horizontally aligned within said reactor.

6. The temperature control system of claim 1, wherein said at least one temperature sensor is vertically aligned such that said measuring tip is directed upwardly.

7. The temperature control system of claim 1, wherein said at least one temperature sensor is vertically aligned such that said measuring tip is directed downwardly.

8. A thermocouple for measuring a temperature within a chemical vapor deposition reactor, said thermocouple comprising:
a sheath having a measuring tip, said sheath being oriented in a substantially vertical manner within said reactor;
a support tube disposed within said sheath;
a first wire and a second wire supported by said support tube, said first and second wires formed of different metals;
a junction formed between said first and second wires, said junction being located adjacent to a distal end of said support tube; and
a spring disposed about a portion of said support tube, said spring is compressed to exert a spring force to bias said junction against said measuring tip, wherein said spring force is at least the minimum amount of force necessary to overcome gravity to maintain said junction in continuous contact with said measuring tip without causing deformation of said junction.

9. The thermocouple of claim 8, wherein the spring is formed of stainless steel.

10. The thermocouple of claim 8, wherein said spring force applied by said spring is between about ten grams (10 g) and about three hundred grams (300 g).

11. The thermocouple of claim 8, wherein said spring force applied by said spring is between about eighteen grams (18 g) and about twenty grams (20 g).

12. The thermocouple of claim 8, wherein said spring has a spring rate of between about one-tenth pounds per inch (0.1 lb/in) and about six pounds per inch (6 lb/in).

13. The thermocouple of claim 8 wherein said spring has a spring rate of about eight one-hundredths pounds per inch (0.08 lb/in).

14. A thermocouple for measuring a temperature within in a chemical vapor deposition reactor, said thermocouple comprising:
a first wire and a second wire, said first and second wires formed of dissimilar metals;
a junction formed by fusing a portion of said first wire with a portion of said second wire;
a support tube having a first distal end and an opposing second distal end, said junction being located adjacent to said first distal end of said support tube;
a sheath configured to surround a portion of said support tube, said sheath having a measuring tip; and
a spring disposed between an outer surface of said support tube and an inner surface of said sheath, said spring having a spring rate and applying a spring force to said support tube;
wherein said spring rate is a minimum spring rate that results in a minimum spring force being applied to said support tube to maintain said junction in continuous contact with said measuring tip without causing deformation of said junction.

15. The thermocouple of claim 14, wherein said spring rate is about 0.8 lb/in.

16. The thermocouple of claim 14, wherein said spring rate is between 0.1 and 6 lb/in.

17. The thermocouple of claim 14, wherein said length of said spring is between about 0.5-9 in.

18. The thermocouple of claim 14, wherein said length of said spring is between about 1-5 in.
